(19) United States
(12) Patent Application Publication
(10) Pub. No.: US 2022/0204314 A1
(43) Pub. Date: Jun. 30, 2022

(54) DIGITAL PROJECTION ON SILVER ELEVATOR DOORS

(71) Applicants: Larissa Farberov, Brooklyn, NY (US); Michael Livi, Livingston, NJ (US); Gary Farberov, Brooklyn, NY (US)

(72) Inventors: Larissa Farberov, Brooklyn, NY (US); Michael Livi, Livingston, NJ (US); Gary Farberov, Brooklyn, NY (US)

(21) Appl. No.: 17/136,403

(22) Filed: Dec. 29, 2020

(51) Int. Cl. B66B 3/00; B66B 1/34

(52) U.S. Cl. CPC B66B 3/008; B66B 1/3492

(57) ABSTRACT

There is a method, a system, and a computer program product that receives information from a set of on-line source and projects the information by devices positioned above elevator doors according to a criteria. Each digital projection system may be independently operated, powered and connected through a server which is controlled and monitored by the building's operations center. Each unit is capable of streaming pre-recorded advertised informational display separately or the operations center can synchronize all the digital projection systems within the building to function as a single unit in the case of live information feed or in case of emergency.

### BACKGROUND

The present invention relates to a computing environment, and more particularly to a computer program, method, and system for projecting content on silver elevator doors.

### SUMMARY

According to one embodiment of the invention, there is a method that includes a processor and a local storage device accessible by the processor for receiving information and projecting the information on silver elevator doors. The information is received from a set of online sources by a structure control unit SCU embedded in a structure. The structure control unit SCU sends the received information to a plurality of digital projection units DPU (DPU1, DPU2, . . . , DPUn) positioned above a plurality of silver elevator doors SED (SED1, SED2, . . . , SEDn). Each digital projection unit DPUi is positioned above the silver elevator door SEDi and is configured to project on the silver elevator door SEDi. The projecting by each digital projection unit DPUi is the received information according to a criteria on the silver elevator door SEDi.

According to one embodiment of the invention, there is provided an information handling system including at least one processor and a local storage device accessible by the processor executing instructions implementing steps of the method that provides for storing information tailored to a user and a condition.

According to one embodiment of the invention, there is provided a computing program product executing instructions on at least one processor including a local storage device accessible by the processor having the steps of the method that provides for storing information tailored to a user and a condition.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a schematic view of a digital distribution center of an embodiment of the invention disclosed herein;

FIG. 2 depicts a schematic view of content transfer in a structure control unit (SCU);

FIG. 3 depicts a schematic view of an example embodiment of a digital projection unit (DPU);

FIG. 4 shows the steps taken by a process that tracks digital content being displayed;

FIG. 5 depicts an embodiment of a digital projection unit (DPU);

FIG. 6 depicts schematic view of a memory mapped file approach for tracking displayed content;

FIG. 7 depicts a schematic view of data flowing through an on-premises system control unit (SCU);

FIG. 8 depicts an example of a directory format where a directory entry (DPCDE) is used as a directory for tracking content;

FIG. 9 depicts more details of the directory; and

FIG. 10 shows a schematic view of a computing system.

### DETAILED DESCRIPTION

Due to a wide availability of mobile and other connected digital devices at the consumer's finger tips, securing a viewer's attention is a challenge. Advertisers and other content providers must compete with various viewer distractions. Advertisers want to capture the attention of their audience using any available channel at their disposal. Commercial and hospitality real estate management companies may need to efficiently relate crucial data to a building's inhabitants.

Most modern multi-story structures have elevators that move people or freight between floors, levels, or decks of a building, vessel, or other structure. Virtually all urban centers, such as, large-scale commercial and hospitality structures have multiple silver metal elevators. The elevators have doors that open and close to allow entry and exit from the elevators.

Many elevators have elevator display systems that typically utilize a small digital screen built-into the wall of the elevator. Some structures may have digital screens available near the elevator.

Many of the existing elevator display systems today do not pause or playback content when movement is not detected near the elevator, such as, the lobby or hallway areas. Content is continuously streamed and do not provide targeted and meaningful messaging.

To overcome the deficiencies of the prior art, embodiments of the invention herein utilize a digital projection elevator system that streams content onto silver metal elevator doors from a digital projection apparatus. The disclosed digital projection elevator system addresses multiple challenges in existence today between existing advertising and content delivery systems and in the manner they operate. The large display screen created by silver metal elevator doors coupled with the anticipation factor for various content creates a new channel to secure the viewer's attention.

The digital projection system may simultaneously stream content in case of fire or other emergencies, announcements, such as, for example, but not limited to, illustrating evacuation plans, and public service announcements (PSA's), such as amber alerts.

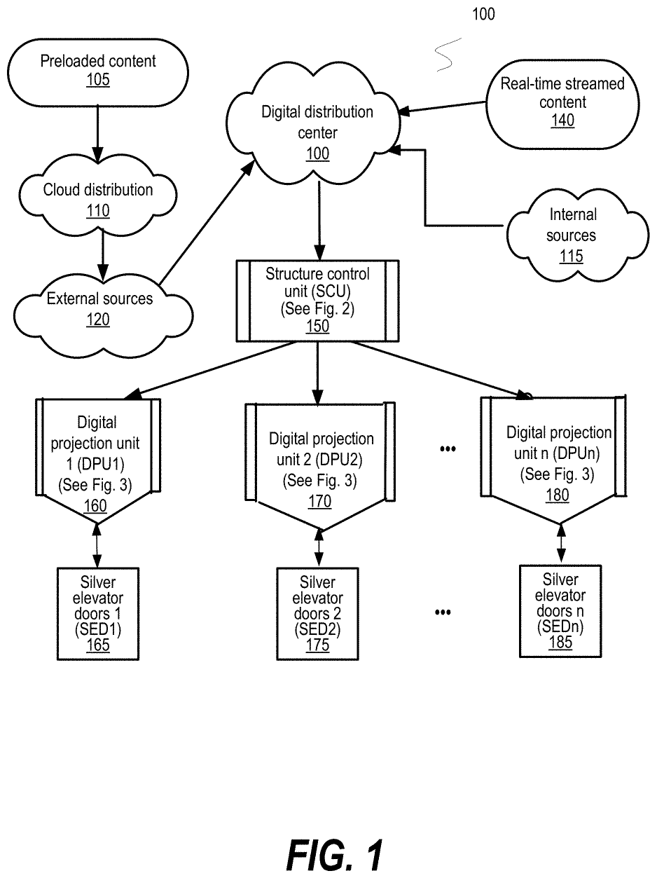

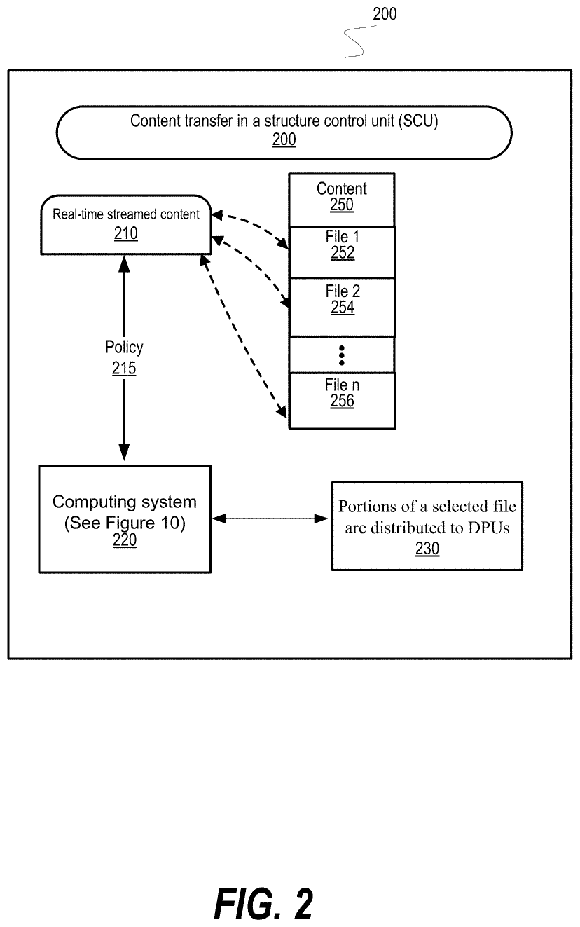

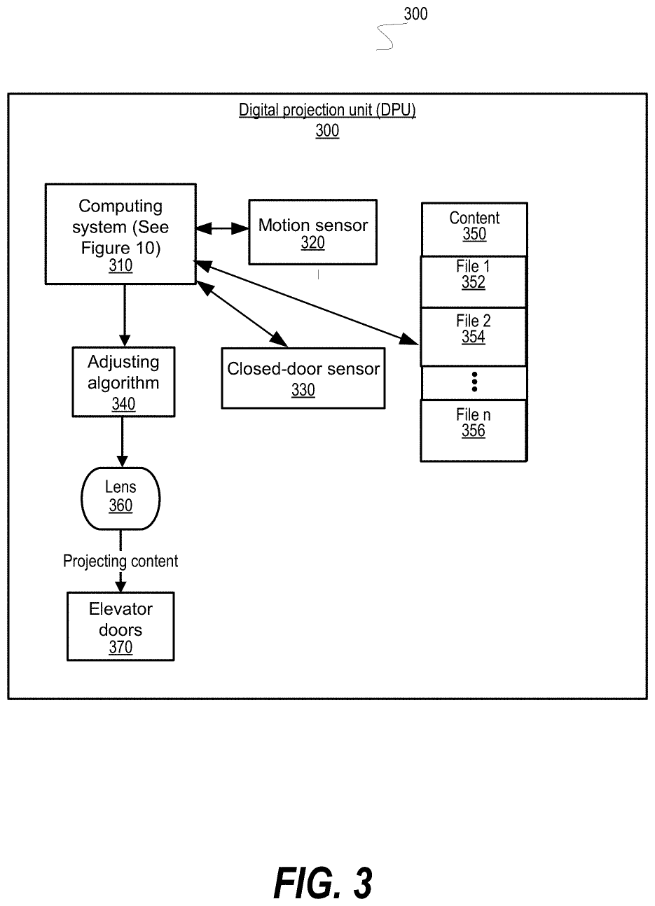

FIG. 1 depicts a schematic view of a digital distribution center 100 of an embodiment of the invention disclosed herein. The digital distribution center 100 receives content to be projected in the system. The received content may be from either external sources 120 external to a building structure or from internal sources 115 being controlled and possibly originating from interior to the building structure. The external sources 120 may be received from various sources, such as, but not limited to a cloud distribution 110 and may include preloaded content 105. The received content may be real-time streamed content 140 received from environmental sources, advertisers, video providers, streaming content providers, and the like. The received content may be dynamically received with only portions available to be projected. Alternatively, the entire streamed content may be captured in a file. In any case, the received content is sent to the structure control unit (SCU) 150 [See FIG. 2 and corresponding text for more details.] The SCU 150 is responsible for sending selected content to each of the Digital projection units DPU1 160, DPU2 170, . . . , DPUn 180. [See FIG. 3 and corresponding text for more details.] The Digital Projection Units DPU1 160, DPU2 170, . . . , DPUn 180 hereafter referred to as DPUs send content to their respective silver elevator doors SED1 165, SED2 175, . . . , SEDn 185 hereafter referred to as SEDs.

In an embodiment, the entire system may be designed for mainly indoor use to be utilized within the exterior lobby and hallways directly above existing elevator banks delivering still and dynamic image. The DPUs may be located above silver elevator doors SEDs in a closed environment such as a lobby or a floor typically located in upscaled high rise office, residential buildings, and hotel buildings and is configured to display on the outside of the doors. The occupants of these buildings, whether working, vacationing, shopping, or living are typically higher than average income and discretionary spending and have developed well defined spending habits.

The DPUs plays content on closed SEDs, suspends playback when the doors are open, and resumes playback when the doors are closed. The displayed content may be, for example, but not limited to, movies, videos, targeted message, such as PSA, and advertising. Playback may be activated through a motion activated mechanism.

In an embodiment, the SCU 150 sends selected content to the DPUs installed above each set of the SEDs and is remotely controlled inside the building where it is located. Each DPU station may be controlled separately or operate as part of a group of displays. The projection control is not constrained to any area of a building, such as a lobby or hallway, and can be placed above any set of silver metal elevator doors. In an embodiment, the SUC 150 may control content projected on a first set of DPUs on a first set of a bank of elevator doors on a first side of a hallway differently from a second set of a second set of DPUs on a second side of a hallway.

In an embodiment, the digital projection elevator system may have a built-in audio system which can accompany any content streamed. The audio functionality may be optional and may be used at the sole discretion of the management or operating company where the projection apparatus is installed. In case of emergency, the building's management or operating group may utilize the audio function of the apparatus to communicate with, or guide passengers to safety. There may be no recording device attached to the projection apparatus, so it may not be possible to capture and project still or live images of the passengers. In this embodiment, the digital projection elevator system can only stream content and cannot capture or record images of the passengers while waiting for an elevator.

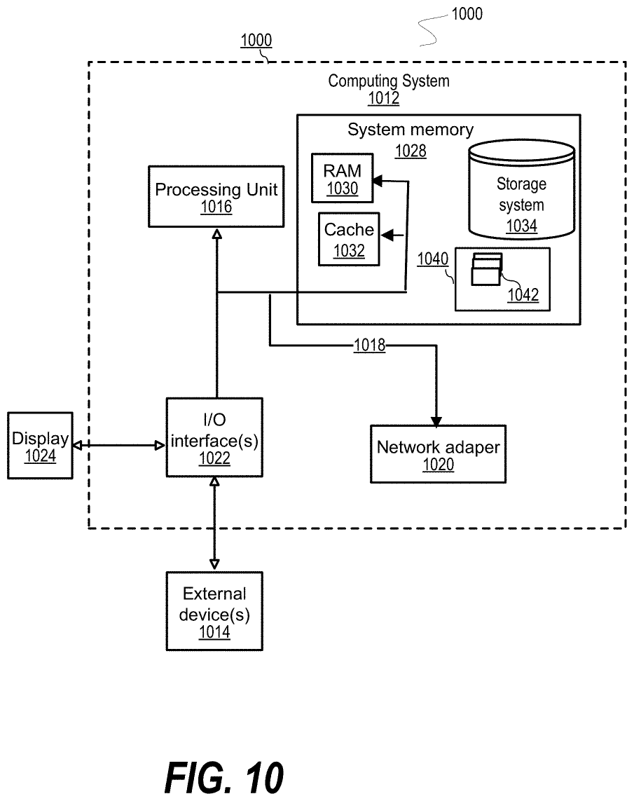

FIG. 2 depicts a schematic view of content transfer in a structure control unit (SCU) 200. Real-time streamed content 210 is received from the digital distribution center 100. The real-time streamed content 210 may be produced by third party advertisers and digitally delivered to the SCU 200 for streaming distribution. The SCU 200 may support separate streaming channels. Each channel may have a stream of information to by fully projected and is identified as separate files, file 1 252, file 2 254, . . . , file n 256 which may be referenced collectively as content 250. In an embodiment, one or more of the files may be advertisements that are projected between segments of a different file. The control of distributing the files to individual DPUs is determined by a policy 215 implemented by a computing system [See FIG. 10 and corresponding text]. Portions of a selected file are distributed to DPUs 230. In an example scenario, a first file i, is scheduled to run at 2:00 PM until completion on a set of silver elevator doors SED′ (SED′1, SED′2, . . . , SED′k) and every 15 minutes, a second file j, is scheduled to run for 30 seconds. The second file j, being for example, an advertisement. The SCU 200 keeps track of the progress of the movie projected on each elevator and the progress of the advertisements projected on each elevator. The data may be transferred to the DPUs along with the policy 215 and the DPU may implement the policy 215. In a different embodiment, the data may be transferred to the DPUs, but control of what is projected and for how long may be controlled by the SCU 200. In this case, the information of what has been projected may be supported internally by Remote Direct Memory Access (RDMA) or via a messaging system. The RDMA approach may, for example, buffer data, and initiate requests to display a selected buffer. The messaging system approach may, for example, queue data to be projected utilizing a set of timing rules derived from the policy 215.

FIG. 3 depicts a schematic view of an example embodiment of a digital projection unit (DPU) 300. The DPU 300 includes a computing system 310 [See FIG. 10 and corresponding text]. The content 350 to be displayed is received from the SCU 200. The content 350 is represented as a series of files, file 1 352, file 2 354, . . . , file n 356. In an embodiment, still images may be in the form of a static advertisement or announcement displayed on the elevator doors without movement. Dynamic images in the form of moving commercial or other promotional material may be created by a third party for mainly promotional use for the viewer. The DPU 300 includes an overhead projection system through a lens 360 configured to project the content 350 as in image downward towards elevator doors 370 which becomes a live screen at the time of the projection.

A detection device in each projection unit is configured to detect the movement of a passenger located underneath the unit and in front of, or in close perimeter to the set of silver doors. A secondary detection device within the unit detects through a connectivity feed when the set of silver elevator doors are in a closed position to activate streaming services. A signal source may include one or more detection sensors, such as, motion sensor 320 and closed-door sensor 330. Projection may be activated, for example, by the motion sensor 320 sensing movement near the elevator doors 370 while the closed-door sensor 330 detects if the doors are closed in order to turn on the projection device and start streaming. The streaming images are prepared to be displayed on the elevator doors 370 by an adjusting algorithm 340 and then projected through a lens 380. The adjusting algorithm 340 may be, for example, a color mapping to facilitate improved visibility of an image projection on the elevator doors 370. In the case of silver elevator doors, a darkening mapping, for example, utilizing a display inverting component or a software algorithm with hardware assistance may be used. The motion sensors 320 may always be activated and communicate with the DPU 300 in real-time, allowing the apparatus to turn on and stream once the above described conditions are met.

Each DPU 300 may communicate and stream content as directed by the SCU 200, a control module, setup within the building's management facilities to control streaming and communications. The SCU 200 and the DPUs 300 may communicate through built-in wireless hubs in the DPUs 300. Electrical conductors for connecting devices to the nearest power source may be included. In the case of a power loss to the building, a backup battery may be included in the DPUs 300 to provide emergency assistance, evacuation instructions, and other PSA's such as amber alerts or other events in real-time. During power loss, the advertising program may cease.

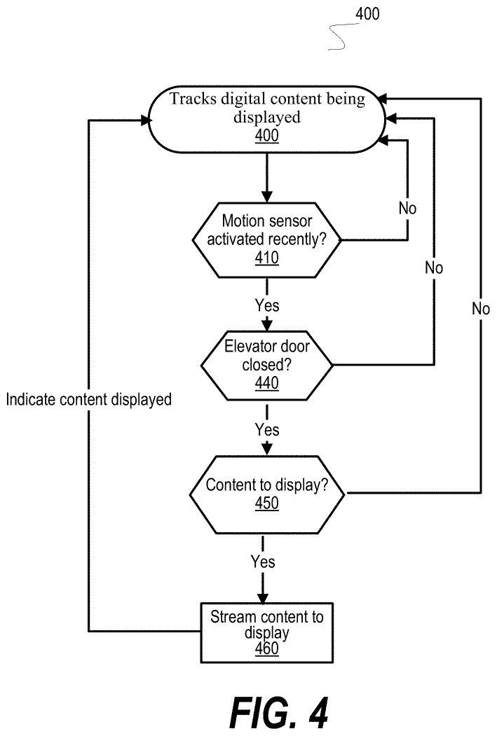

FIG. 4 shows the steps taken by a process that tracks digital content being displayed 400. The process determines as to whether motion sensor activated recently (decision 410). If not motion sensor activated recently, then decision 410 loops back to step 400. If motion sensor activated recently, then decision 410 branches to the ‘yes’ branch which continues to determine if elevator doors closed 440. If not elevator door closed, then decision 440 loops back to step 400. If elevator door closed, then decision 440 branches to the ‘yes’ branch which determines as to whether content to display (decision 450). If content to display, then decision 450 branches to the ‘yes’ branch which proceeds to stream content to display 460. The process then loops back to 400 while indicating the content displayed. If no content to display, then decision 450 loops back to step 400. All content streaming operations may cease after a sensor is triggered due either to opening of the elevator doors directly underneath the projection apparatus or due to lack of motion.

The activated recently (decision 410) may be integrated into the policy 215. In an example embodiment, a limited time-out of say, 30 minutes might be used. In other embodiments, information from other sensors from Internet of Things (IoT) might be used to determine if there is person in the vicinity of the elevator.

The control circuit may receive signals from each projection apparatus indicating a location of a person, for example, utilizing a sonar detection located within the projector. The control circuit and may include local memory to store additional content in the video memory unit of the projection apparatus in order to continue streaming paused content or deliver new images.

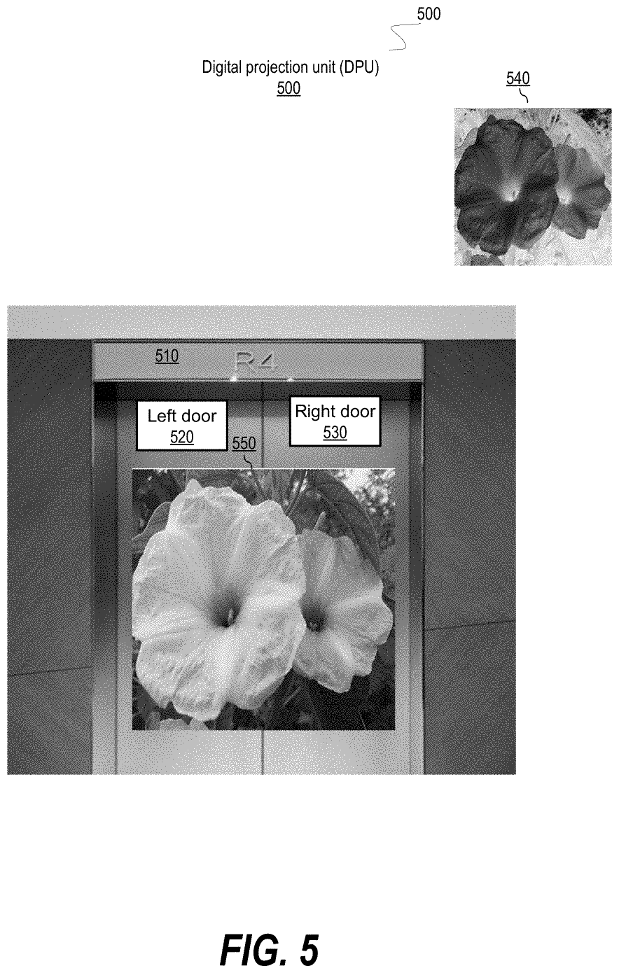

FIG. 5 depicts an embodiment of a digital projection unit (DPU) 500. The DPU 500 may be physically embedded or attached to a housing 510 located above the elevator doors 370. Left door 520 and right door 530 slide inside the housing 510 for passengers to enter an elevator cab. The surface of the housing 510 may include the motion sensor 320, the closed-door sensor 330 and the lens 360. In an embodiment, the lens 360 projects a single adjusted square image 540 across the left door 520 and the right door 530. The single adjusted square image 540 becomes the projected image 550 due to color combining of the adjusted square image 540 and the silver color of the elevator doors 370. In a different embodiment more lenses may be used to break the projection into different areas to facilitate projection on an expanded area of the elevator doors 370.

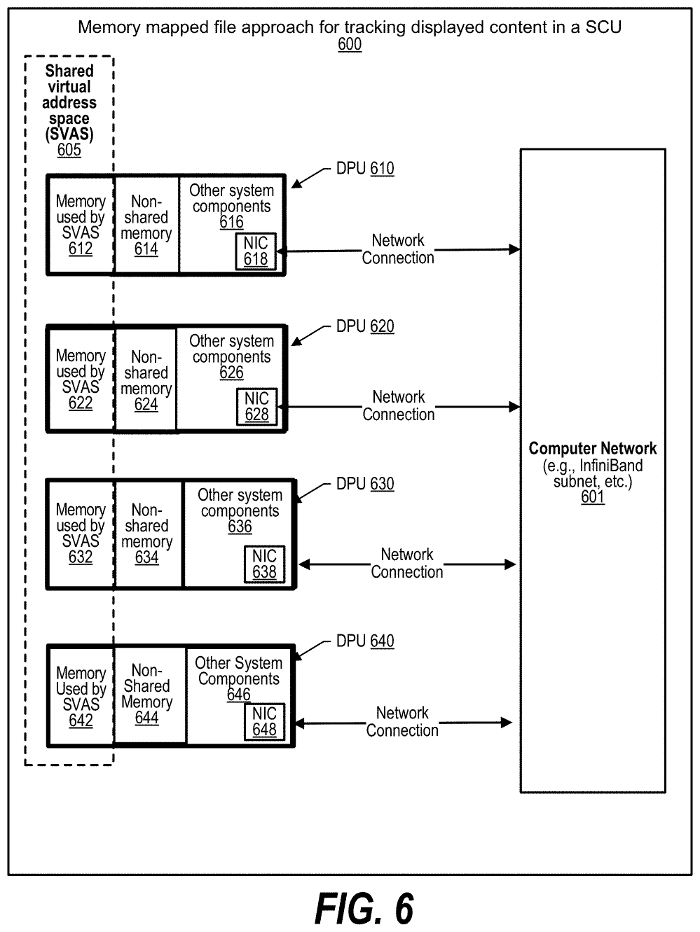

FIG. 6 depicts schematic view of a memory mapped file approach for tracking displayed content in a structure control unit (SCU) 600. Each file may be mapped into a portion of a shared virtual address space (SVAS), where each file has a start virtual address and a length. The maximum possible size of each file may be obtained from the content provider, so the virtual address may be used to access each portion of the file. Each DPU may be running several application processes under its own operating system. A virtual address translation mechanism converts virtual addresses in a user application to these real addresses. During application execution, the operating system may relocate the physical contents pointed to by a virtual address to some other medium like non-volatile memory or disk. In this case, the application's operation stalls until the physical contents are moved back into Dynamic Random Access Memory (DRAM) and address translation is re-established by the operating system. In an embodiment, each file may be mapped to a shared virtual address space (SVAS) across all DPUs in the system. Each DPU [610, 620, 630, 640] may dedicate a portion of its virtual address space to be used only locally, identified as Non-Shared Memory [614, 624, 634, 644]. Another portion of the virtual address space may be dedicated for addressing memory used by the Shared Virtual Address Space (SVAS) [612, 622, 632, 642] which may also be referenced as “shared virtual memory.” The SVAS memory may contain content from a remote location retrieved via a network interface controller (NIC) [618, 628, 638, 648] utilizing a network connection to a computer Network (e.g. Infiniband, subnet, etc.) 601. In an example implementation, the content may be received via a socket connection. Other system components [616, 626, 636, 646] may directly access the memory in the SVAS [612, 622, 632, 642]. The memory referenced by a shared virtual address may be a cached on the SCU or on the DPU, that is be a replica of slower memory or memory on a remote location that is stored in the memory local to the location reducing the access latency. Each of the DPUs in FIG. 6 may have a similar infrastructure or vary.

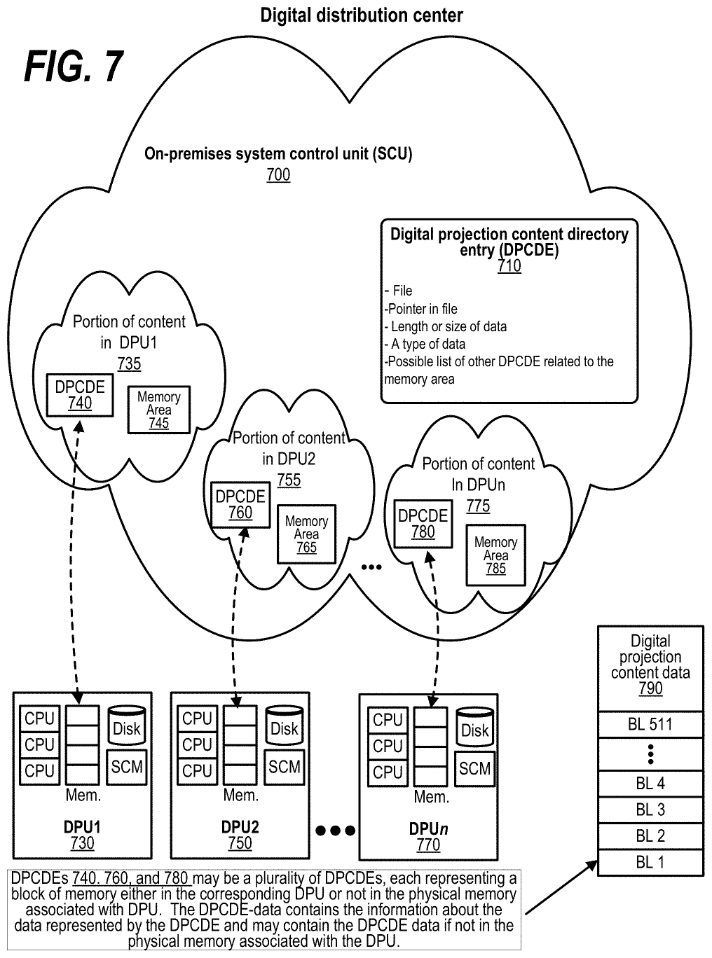

FIG. 7 depicts a schematic view of data flowing from a digital distribution center through an on-premise system control unit (SCU) 700. The SCU 700 may receive streaming data from various sources, such as, advertisers and distributers of streaming data. In an embodiment, each of the received files are referenced in a digital projection content directory (DPCD) containing digital projection content directory entries (DPCDEs). In an embodiment, an individual directory entry may identify a file, a pointer in the file, and a length of a segment of the file. Alternatively, an individual directory entry may point to other directory entries in a recursive manner until identifying the file data. In an embodiment that allows different digital projection units (DPUs) to project different content, the SCU may keep track of the data sent to individual SCUs and which data have been displayed. In the schematic view, a portion of the content in DPU1 735 is indicated by the DPCDE 740 which is in memory area 745 local to the SCU 700. Similarly, a portion of the content in DPU2 755 is indicated by DPCDE 760 which is in memory area 765. The schematic view continues depicting a portion of content in DPUn 775 is indicated by DPCDE 780 which is in memory area 785. The DPCDEs 740, 760, and 780 may directly correspond to memory areas in the DPUs 730, 750, 770 or they may be a plurality of DPCDEs, each representing a block of memory either in the corresponding DPU or not in the physical memory associated with the DPU. The block size may be a size configured for the system, for example, but not limited to a cache line size or a page size. The DPCDE-data contains the information about the data represented by the DPCDE and may contain the DPCDE data if not in the physical memory associated with the DPU. The digital projection content data 790 is referenced by pointers following according to the DPCDE structure.

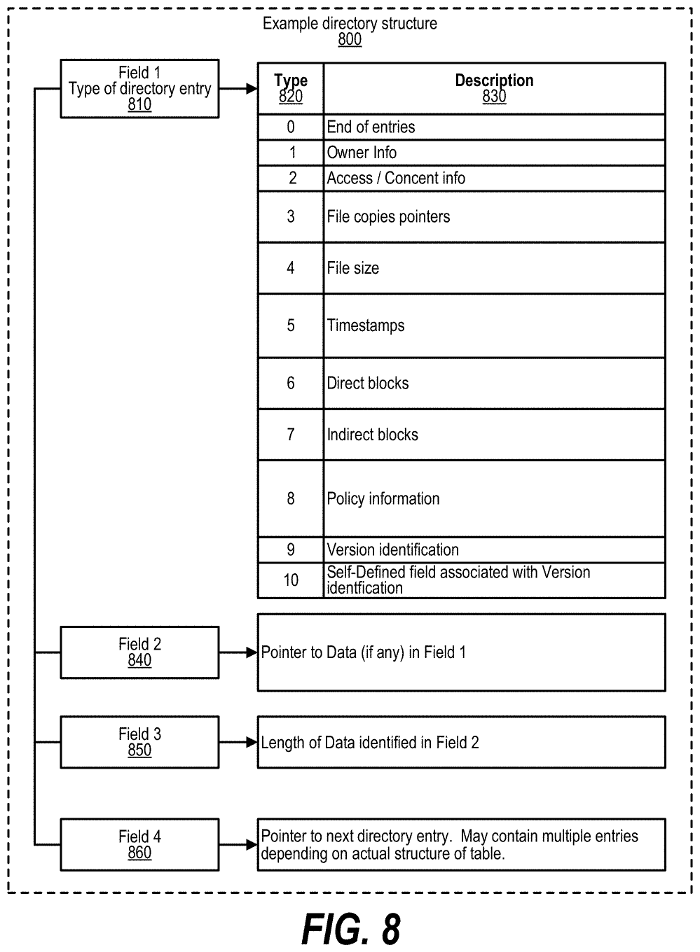

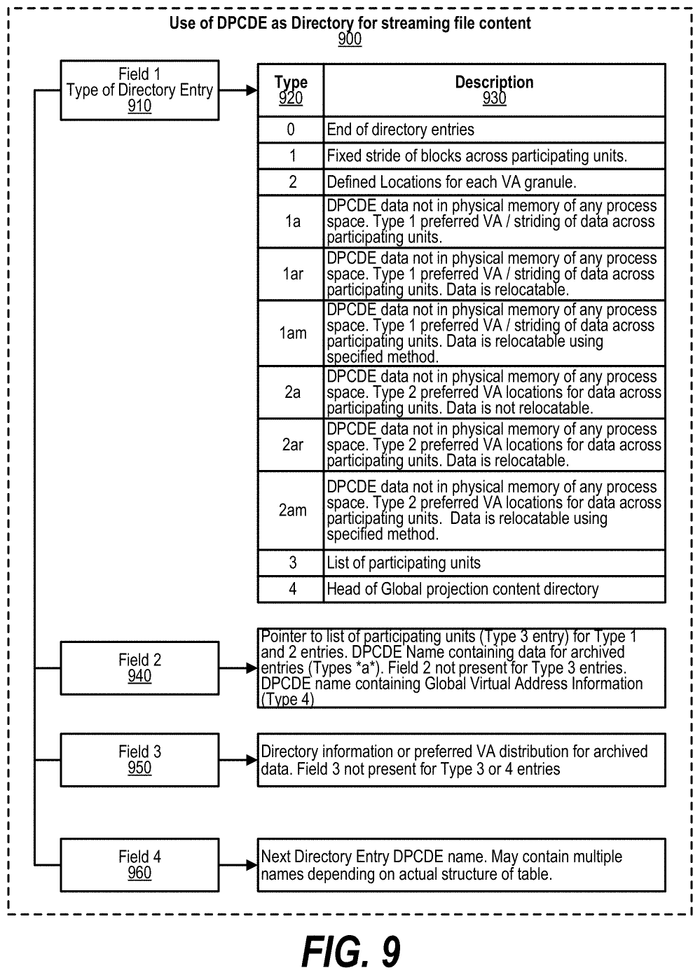

FIG. 8 depicts an example of a directory format where a directory entry (DPCDE) is used as a directory for digital projection content directory entry (DPCDE) 710 being used as record entries for a home node directory 860. The actual type numbers could be different to allow a combination of directory formats. Each directory entry (one for each virtual memory area or range of virtual addresses) has a type field that identifies the type of directory entry. In an embodiment, Type=0 810 indicates the end of directory entries. Type=1 820 indicates a fixed stride of blocks across participating units. Type 1 includes fields such as a preferred virtual address (VA)/striding of data across participating DPUs. Type=2 825 indicates a defined location for each VA granule. Type=1 a 830 indicates the data is not in physical memory of any process space. Type=2 825 identifies DPUs and preferred VA locations for data across the participating units. Type=3 840 identifies participating units. Type=4 850 identifies a head of digital projection content directory (DPCD). Depending on the type different field are included. Fields may include entries, such as, but not limited to a pointer to list of participating units (Types 1, 2, and 3), a plurality of data entry names containing shared virtual address information or archive information. More details of the individual filed are described in FIG. 9.

FIG. 9 depicts more details of the example of directory format in an embodiment using DPCDE as directory for streaming file content 900. Field 1 depicts the type of directory entry wherein the Type 920 includes the individual type entries in FIG. 8 and some additional entries as follows: Type=1 ar indicates data not in physical memory of any process space. Type=1 am indicates data not in physical memory of any process space. Type=2a indicates data not in physical memory of any process space. Type=2ar indicates data not in physical memory of any process space. Type=2 am indicates data not in physical memory of any process space. The data entry refers to data for archived entries (Types *a*). Field 2 940 points to list of participating units for type 1, 2, and 3. Field 2 is not present for Type 3 entries. Data entry containing shared virtual address information (Type 4). Field 3 950 contains directory information or a preferred virtual address distribution for archived data. Field 3 is not present for Type 3 or 4 entries. Field 4 960 contain next directory entry data and may contain multiple entries depending on the actual structure of directory.

Referring to FIG. 10, a schematic of a processing system 1000 is shown wherein the methods of this invention may be implemented. The processing system 1000 is only one example of a suitable system and is not intended to suggest any limitation as to the scope of use or functionality of embodiments of the invention described herein. Regardless, the system 1000 can implement and/or performing any of the functionality set forth herein. In the system 1000 there is a computer system 1012, which is operational with numerous other general purpose or special purpose computing system environments or configurations. Examples of well-known computing systems, environments, and/or configurations that may be suitable for use with the computer system 1012 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 1012 may be described in the general context of computer system-executable instructions, such as program modules, being executed by a computer system. Generally, program modules may include routines, programs, objects, components, logic, data structures, and so on that perform tasks or implement abstract data types. The computer system 1012 may be practiced in distributed cloud computing environments where tasks are performed by remote processing devices that are linked through a communications network. In a distributed cloud computing environment, program modules may be in both local and remote computer system storage media including memory storage devices.

As shown in FIG. 10, the computer system 1012 in the system environment 1000 is shown in the form of a general-purpose computing device. The components of the computer system 1012 may include, but are not limited to, a set of one or more processors or processing units 1016, a system memory 1028, and a bus 1018 that couples various system components including the system memory 1028 to the processor 1016.

The bus 1018 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnects (PCI) bus.

The computer system 1012 typically includes a variety of computer system readable media. Such media may be any available media that is accessible by the computer system 1012, and it includes both volatile and non-volatile media, removable and non-removable media.

The system memory 1028 can include computer system readable media in the form of volatile memory, such as random-access memory (RAM) 1030 and/or a cache memory 1032. The computer system 1012 may further include other removable/non-removable, volatile/non-volatile computer system storage media. By way of example only, a storage system 1034 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1018 by one or more data media interfaces. As will be further depicted and described below, the system memory 1028 may include at least one program product having a set (e.g., at least one) of program modules 1042 that are configured to carry out the functions of embodiments of the invention.

A program/utility 1040, having the set (at least one) of program modules 1042, may be stored in the system memory 1028 by way of example, and not limitation, as well as an operating system, one or more application programs, other program modules, and program data. Each of the operating systems may have one or more application programs, other program modules, and program data or some combination thereof, and may include an implementation of a networking environment. The program modules 1042 generally carry out the functions and/or methodologies of embodiments of the invention as described herein.

The computer system 1012 may also communicate with a set of one or more external devices 1014 such as a keyboard, a pointing device, a display 1024, a tablet, a digital pen, etc. wherein these one or more devices enable a user to interact with the computer system 1012; and/or any devices (e.g., network card, modem, etc.) that enable the computer system 1012 to communicate with one or more other computing devices. Such communication can occur via Input/Output (I/O) interfaces 1022. These include wireless devices and other devices that may be connected to the computer system 1012, such as, a USB port, which may be used by a tablet device (not shown). Still yet, the computer system 1012 can communicate with one or more networks such as a local area network (LAN), a general wide area network (WAN), and/or a public network (e.g., the Internet) via a network adapter 1020. As depicted, a network adapter 1020 communicates with the other components of the computer system 1012 via the bus 1018. It should be understood that although not shown, other hardware and/or software components could be used in conjunction with the computer system 1012. Examples include, but are not limited to microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method that includes a processor and a local storage device accessible by the processor for receiving information and projecting the information on silver doors comprising:
receiving information from a set of online sources by a structure control unit SCU embedded in a structure wherein the structure control unit SCU sends the received information to a plurality of digital projection units DPU (DPU1, DPU2, . . . , DPUn) positioned above a plurality of silver elevator doors SED (SED1, SED2, . . . , SEDn) wherein the each digital projection unit DPUi is positioned above the each silver elevator door SEDi and configured to project on the silver elevator door SEDi; and
projecting by the digital projection unit DPUi the received information according to a criteria on the silver elevator door SEDi.

2. The method of claim 1, further comprising:
adjusting the received information during the projecting.

3. The method of claim 1, wherein the criteria includes a door state wherein the door state is one of an open state and a closed state.

4. The method of claim 3, wherein the projecting occurs in the closed state and the projection is prevented in the open state.

5. The method of claim 4, wherein the silver elevator doors SEDi is in a closed state and the silver elevator doors SEDj is in an open state and the method further comprises:
projecting a first set of information on the silver elevator doors SEDi while in the closed state;
inhibiting projecting the first set of information on the silver elevator doors SEDj while in the open state; and
responsive to detecting the second silver elevator doors SEDj is in the closed state, projecting the first set of information on the silver elevator doors SEDj.

6. The method of claim 1, wherein the received information is from a source external to the structure.

7. The method of claim 1, wherein the received information is from a source internal to the structure.

8. The method of claim 1, wherein the digital projection unit DPUi further comprises a motion sensor MSi and a door closed sensor DCSi.

9. The method of claim 8, wherein the criteria for projecting on the silver elevator doors SEDi includes a detection of an activation by the motion sensor MSi and a detection of the closed state by the door closed sensor DCSi.

10. An information handling system for receiving information and projecting the information on silver doors comprising:
one or more processors;
a memory coupled to at least one of the processors;
a network interface that connects the local device to one or more remote web sites; and
a set of computer program instructions stored in the memory and executed by at least one of the processors in order to perform actions comprising:
receiving information from a set of online sources by a structure control unit SCU embedded in a structure wherein the structure control unit SCU sends the received information to a plurality of digital projection units DPU (DPU1, DPU2, . . . , DPUn) positioned above a plurality of silver elevator doors SED (SED1, SED2, . . . , SEDn) wherein the each digital projection unit DPUi is positioned above the each silver elevator door SEDi and configured to project on the silver elevator door SEDi; and
projecting by the digital projection unit DPUi the received information according to a criteria on the silver elevator door SEDi.

11. The information handling system of claim 10, further comprising:
adjusting the received information during the projecting.

12. The information handling system of claim 10, wherein the criteria includes a door state wherein the door state is one of an open state and a closed state.

13. The information handling system of claim 12, wherein the projecting occurs in the closed state and the projection is prevented in the open state.

14. The information handling system of claim 13, wherein the silver elevator doors SEDi is in a closed state and the silver elevator doors SEDj is in an open state and the method further comprises:
projecting a first set of information on the silver elevator doors SEDi while in the closed state;
inhibiting projecting the first set of information on the silver elevator doors SEDj while in the open state; and
responsive to detecting the second silver elevator doors SEDj is in the closed state, projecting the first set of information on the silver elevator doors SEDj.

15. A computer program for receiving information and projecting the information on silver doors stored in a computer readable storage medium, comprising computer program code that, when executed by an information handling system, performs actions comprising:
receiving information from a set of online sources by a structure control unit SCU embedded in a structure wherein the structure control unit SCU sends the received information to a plurality of digital projection units DPU (DPU1, DPU2, . . . , DPUn) positioned above a plurality of silver elevator doors SED (SED1, SED2, . . . , SEDn) wherein the each digital projection unit DPUi is positioned above the each silver elevator door SEDi and configured to project on the silver elevator door SEDi; and
projecting by the digital projection unit DPUi the received information according to a criteria on the silver elevator door SEDi.

16. The computer program product of claim 15, further comprising:
adjusting the received information during the projecting.

17. The computer program product of claim 15, wherein the criteria includes a door state wherein the door state is one of an open state and a closed state.

18. The computer program product of claim 17, wherein the projecting occurs in the closed state and the projection is prevented in the open state.

19. The computer program product of claim 18, wherein the silver elevator doors SEDi is in a closed state and the silver elevator doors SEDj is in an open state and the method further comprises:
projecting a first set of information on the silver elevator doors SEDi while in the closed state;
inhibiting projecting the first set of information on the silver elevator doors SEDj while in the open state; and
responsive to detecting the second silver elevator doors SEDj is in the closed state, projecting the first set of information on the silver elevator doors SEDj.

20. The computer program product of claim 15, wherein the received information is from a source external to the structure.
